(19) United States
(12) Patent Application Publication
(10) Pub. No.: US 2009/0263048 A1
(43) Pub. Date: Oct. 22, 2009

(54) Bag Structures And Methods Of Assembling The Same

(76) Inventors: Michael Louis Iannelli, II, Thompsons Station, TN (US); Julie Rossing Smith, Pace, FL (US); Jason L. Raines, Oxford, IN (US); Gary Alan Fulk, Milton, FL (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/424,182

(22) Filed: Apr. 15, 2009

Related U.S. Application Data
(60) Provisional application No. 61/045,484, filed on Apr. 16, 2008.

(51) Int. Cl. B65D 33/16; B29C 65/48; B29C 65/08

(52) U.S. Cl. 383/64; 156/66; 156/73.1; 156/69

(57) ABSTRACT

A bag structure includes a bag body including side walls having inner and outer surfaces, and the bag body further includes a top end and a bottom end. A closure member is coupled to the top end for opening and closing the bag body, and an inner seal is formed proximate to the top end, without the use of heat driven from the outside surface of the bag wall to the inside surface of the bag wall. Further, the top end of the bag is folded over, and an adhesive member is secured to the bag body. The adhesive member includes a reinforced section and an adhesive section. The adhesive member is configured to retain the top end of the bag body in a folded over relationship until the adhesive member is severed along the reinforced section.

### REFERENCE TO RELATED APPLICATION

Priority is claimed to the filing date of U.S. provisional patent application Ser. No. 61/045,484 filed on Apr. 16, 2008, the disclosure of which is hereby incorporated by reference.

### TECHNICAL FIELD

This invention relates generally to bag structures, and more particularly to a single layer woven bag structure having improved loading, access, and tamper evident features.

### BACKGROUND

At least some known bag structures may be fabricated from a single ply of material or from multiple plies or layers. The bag structures may be fabricated from paper, plastic, or a combination of paper and plastic materials. Typically, multiwall bags are fabricated as tubes formed from a plurality of paper plies. In addition to having paper plies, at least some known multiwall bags contain one or more plies, typically the innermost one or more plies, fabricated from a thin plastic material, or alternatively coated with a resinous material, to provide a degree of moisture resistance to the finished bag. In addition, at least some known single ply bag structures are fabricated from a plastic-based woven material. For example, at least some known single ply bag structures are formed from a single layer of woven polypropylene (“WPP”).

Closure of the multiwall bag structures is typically accomplished by applying adhesive (e.g., hot melt or sonically activatable adhesive) to the outer surface of the bag and folding over the top end. Closing the bag by simply folding and adhesively affixing the flap provides a pointed, pinch bottom closure. The opposite end of the bag may be likewise provided with a pinch bottom closure, or it may be closed and sealed in a different configuration, such as a diamond or rectangular configuration, so that the pinch “bottom” may actually be the top of the bag, as may be found commonly in bags containing dry granular material, like dog food, cat litter, or fertilizer. When such a bag is closed and sealed, the folded over closure is typically quite strong, and requires cutting of the bag plies below the folded over and sealed closure, in order to gain access to the contents of the bag. Moreover, once such bags are opened, the bags cannot be reclosed or resealed. In at least some known cases, the entire contents of the bag are not emptied at one time, but rather are removed from the bag over a period of time. In these cases, the contents remaining in the bag after opening may spoil quickly or are susceptible to spillage through the opening.

In order to facilitate opening and closing of multiwall bag structures, some multiwall bag structures are known that incorporate a zipper that may be opened and closed. At least some of these known multiwall bag structures also include a slider to aid in opening and closing of the zipper. Typically, zippers on multiwall bag structures are heat-sealed to an inner surface of the bag using heat applied directly to an external surface of the bag. At least some known multiwall bag structures further include an internally sealed portion between at least one end of the bag and the product storage area of the bag, for example to protect a zipper at the end of the bag from damage while the bag is being filled with product from the other end, or to ensure product freshness and provide a barrier against insects infiltrating the bag end. Like the attachment of zippers, the creation of internally sealed portions for multiwall bags is known to be facilitated by processes that use heat applied directly to one or more external surfaces of the multiwall bag, such that the heat must travel through the bag wall to heat an adhesive coating on the inner surface of the bag wall.

Closure of single ply woven bags is typically accomplished by sewing or double-folding and taping. Because of the high strength of the woven bag substrate, these woven bags also are difficult to open to access the contents. Woven bags also typically cannot be resealed. Accordingly, it would be beneficial to use zippers and to use an internally sealed portion, as known for multiwall bags, in a single ply woven bag. However, heat applied directly to one or more external surfaces of a woven bag for the purpose of affixing a zipper to an inner bag surface or creating an internally sealed portion, as known for multiwall bags, typically creates an area of structural weakness in single ply woven bags because the plastic used to form the woven layer loses its integrity when heat passes through the layer to an inner surface. Therefore, affixing a zipper or creating an internally sealed portion in a single layer woven bag using methods known for multiwall bags will oftentimes damage the bag and make the bag susceptible to rupture. Accordingly, a single layer woven bag having a reclosable closing member and an internal seal zone is needed. Moreover, a method for making such a single layer woven bag without damaging the strength of the bag is needed.

### SUMMARY

In one aspect, a bag structure is provided including a bag body including front and rear walls each having inner and outer surfaces, and the bag body further including a top end and a bottom end. A closure member is coupled to the top end for opening and closing the bag body, and an adhesive member is secured to the bag body. The adhesive member includes a reinforced section and an adhesive section. The adhesive member is configured to retain the top end of the bag body in a folded over relationship until the adhesive member is severed along the reinforced section. The bag structure further includes an internal seal zone formed proximate the top end of the bag body such that at least a portion of the front wall inner surface is releasably coupled to at least a portion of the rear wall inner surface.

In another aspect, a poly woven slider bag is provided including a bag body having a front wall, a rear wall, and side walls extending therebetween. The bag body has a top end and a bottom end, wherein the front, rear, and side walls extend between the top end and the bottom end. A zipper member is coupled to the front and rear walls at the top end of the bag body. The zipper member extends along a portion of the top end of the bag body. A slider clip is coupled to the zipper member for opening and closing the zipper member, and an adhesive member extends along the zipper member. The adhesive member includes an adhesive section configured to secure the adhesive member to the bag body and a reinforced section extending substantially an entire length of the adhesive member. The adhesive member is secured to the bag body proximate the top end and is configured to retain the top end of the bag body in a folded over position until the adhesive member is severed. The slider bag further includes an adhesive coating applied to at least one of the front wall inner surface and the rear wall inner surface proximate the top end of the bag body, wherein the adhesive coating is activated by at least one of electromagnetic energy, pressure, and sonic vibration for creating an internal seal zone wherein at least a portion of the front wall inner surface is releasably coupled to at least a portion of the rear wall inner surface.

In a further aspect, a method of assembling a bag structure is provided. The bag structure includes front, rear, and side walls extending between top and bottom ends of the bag structure. The bag structure also includes a zipper member, a slider clip, and an adhesive member having an adhesive section and a reinforced section. The method includes applying an adhesive coating to at least one of a front wall inner surface and a rear wall inner surface proximate the top end of the bag body and applying at least one of electromagnetic energy, pressure, and sonic vibration for creating an internal seal zone, wherein at least a portion of the front wall inner surface is releasably coupled to at least a portion of the rear wall inner surface. The method also includes attaching the zipper member with the slider clip to the top end of the bag structure without applying heat to an internal surface of the bag structure, wherein the slider clip is configured to open and close the zipper member. The method further includes folding over the top end of the bag structure along a fold line to define a top flap, and securing the top flap to an outer surface of the bag structure using the adhesive member, wherein the top flap is released upon severing the adhesive member at the reinforced section.

### BRIEF DESCRIPTION OF THE DRAWINGS

FIG. 1 is a top perspective view of a single ply woven bag in an open position.

FIG. 2 is a top perspective view of the single ply woven bag shown in FIG. 1 with a zipper member and slider clip attached thereto.

FIG. 3 is a cross sectional view of the single ply woven bag shown in FIG. 1.

FIG. 4 is a cross sectional view of the single ply woven bag shown in FIG. 1 with an inner seal formed along a top portion of the bag.

FIG. 5 is a top perspective view of the single ply woven bag shown in FIG. 4 with a zipper member and slider clip attached at a top portion of the bag with the top portion folded over and an adhesive member affixed along the folded over portion.

FIG. 6 is a cross sectional view of the single ply woven bag shown in FIG. 5.

FIG. 7 is a schematic view of a forming machine that may be used to manufacture the single ply woven bag shown in FIGS. 1-6.

### DETAILED DESCRIPTION

The disclosed embodiments facilitate the use of a reclosable closure member (e.g., a zipper) and an internal seal zone with a single ply woven bag structure. The embodiments described herein include closure members such as zippers that are affixed to an inner surface of the bag structure using an adhesive that may be activated by electromagnetic energy (e.g., radio frequency radiation or Ultraviolet (UV) radiation), or by pressure applied externally to the bag structure, or by sonic vibration, rather than by heat conducted through the woven ply from an outer bag surface to an inner bag surface. The embodiments also include closure members such as zippers that are affixed to an outer surface of the bag structure using an adhesive that may be activated by direct heat, wherein the heat is directionally and/or temperature-controlled such that it does not travel from the outer bag surface through the woven ply to an internal bag surface. Furthermore, the embodiments also include internal seal zones created using an adhesive that may be activated by electromagnetic energy (e.g., radio frequency or UV radiation), or by pressure applied externally to the bag structure, or by sonic vibration, rather than by heat conducted through the woven ply from an outer bag surface to an inner bag surface. Because the closure member and the internal seal zone are applied to the single ply woven bag of the present invention without the use of heat driven from the outside surface of the woven ply to the inside surface of the woven ply, the closure member and the inner seal zone may be fabricated without damaging or weakening the bag structure.

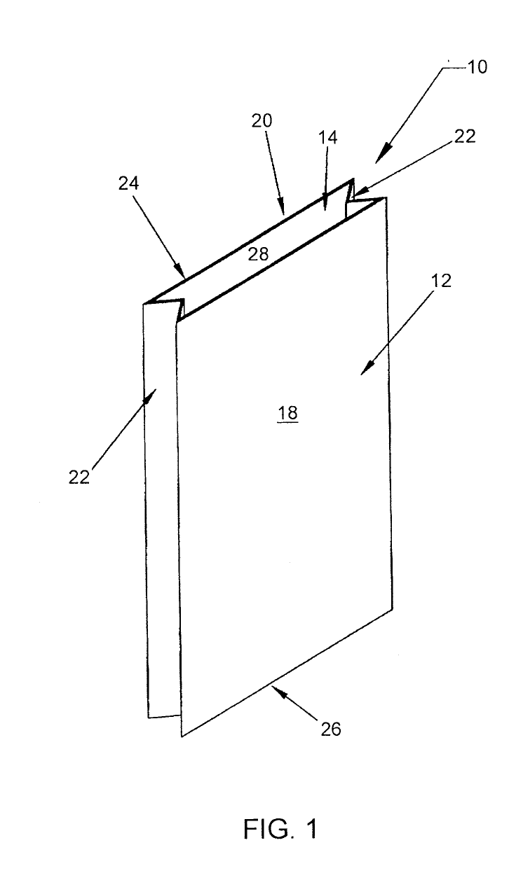

FIG. 1 is a top perspective view of a bag 10 in an open configuration. In the example embodiment, bag 10 is constructed as a tubular body 12 formed from a single layer or ply 14 of woven material. For example, layer 14 may be formed from a plastic-based woven material, more specifically a woven polypropylene (“WPP”) material. In alternative embodiments, layer 14 is manufactured from woven polyethylene or other polymers.

Bag 10 includes a front wall 18, a rear wall 20, and side walls 22. In the exemplary embodiment, side walls 22 are gusseted such that bag 10 may be folded flat. Bag 10 also includes a top end or mouth 24 and a bottom end 26. When formed, each of top and bottom ends 24 and 26 are open to a cavity 28. Cavity 28 is configured to receive a product (not shown). In the exemplary embodiment, bag 10 is bottom loaded such that the product is filled into cavity 28 through bottom end 26, and then bottom end 26 is sealed or otherwise closed.

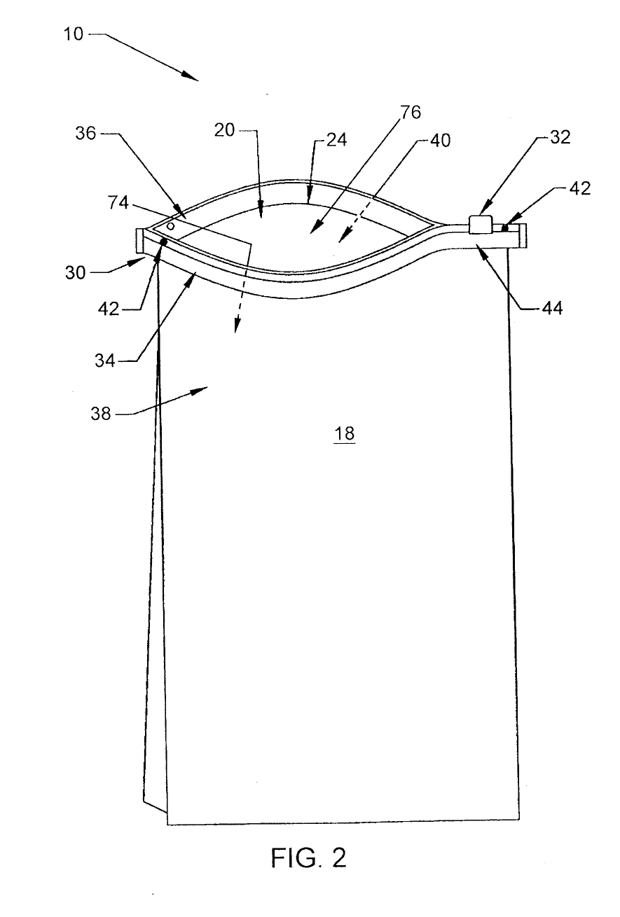

FIG. 2 is a perspective view of bag 10 with a zipper member 30 and slider clip 32 attached thereto. Zipper member 30 includes first and second zipper profiles 34 and 36, respectively, coupled to top end 24 of bag 10. First zipper profile 34 is attached to front wall 18, and second zipper profile 36 is attached to rear wall 20. In one embodiment, each zipper profile 34 and 36 includes a track and an attachment flange extending from the track. The ends of the zipper member 30 are sealed to one another, such as by an ultrasonic sealing process. Zipper profiles 34 and 36 are releasably coupled to one another, and more particularly, the tracks of each zipper profile 34 and 36 are releasably coupled to one another. As such, bag 10 may be opened to access the product within bag 10 and closed again to restrict access to the product using zipper member 30. In the exemplary embodiment, zipper member 30 extends beyond the outer edges of front and rear walls 18 and 20. Alternatively, zipper member 30 extends for a length less than a width of front and rear walls 18 and 20. In the exemplary embodiment, zipper member 30 is opened and closed using slider clip 32.

First zipper profile 34 is attached to an outer surface 38 of front wall 18, and second zipper profile 36 is attached to an outer surface 40 of rear wall 20, using an adhesive. In one embodiment, the adhesive may be activated by an application of direct heat, wherein at least one of the temperature and direction of the applied heat is controlled to limit substantially the amount of heat conducted from front wall outer surface 38 and rear wall outer surface 40 into the interior of woven layer 14. Alternatively, the adhesive may be activated by one of electromagnetic energy, pressure applied externally to bag 10, and sonic vibration. In an alternative embodiment, first zipper profile 34 is attached to an inner surface 74 of front wall 18 and second zipper profile 36 is attached to an inner surface 76 of rear wall 20 using an adhesive that may be activated by one of electromagnetic energy, pressure applied externally to bag 10, and sonic vibration. Accordingly, zipper profiles 34 and 36 may be affixed to front wall 18 and rear wall 20, respectively, without the need for heat conduction through the interior of woven layer 14. The reclosable zipper member 30 may therefore be affixed to bag 10 without damaging or weakening bag 10.

In the exemplary embodiment, bag 10 includes a plurality of end stops 42 for limiting a range of motion of slider clip 32 along zipper member 30. End stops 42 project outward from an outer portion 44 of zipper member 30. In one embodiment, end stops 42 project outward from each of first and second zipper profiles 34 and 36. Additionally, end stops 42 are positioned proximate each end of zipper member 30. End stops 42 project outward a distance sufficient to contact slider clip 32 as slider clip 32 is moved along zipper member 30. In the exemplary embodiment, end stops 42 are glue drops or glue beads that are applied to zipper member 30 during fabrication of bag 10.

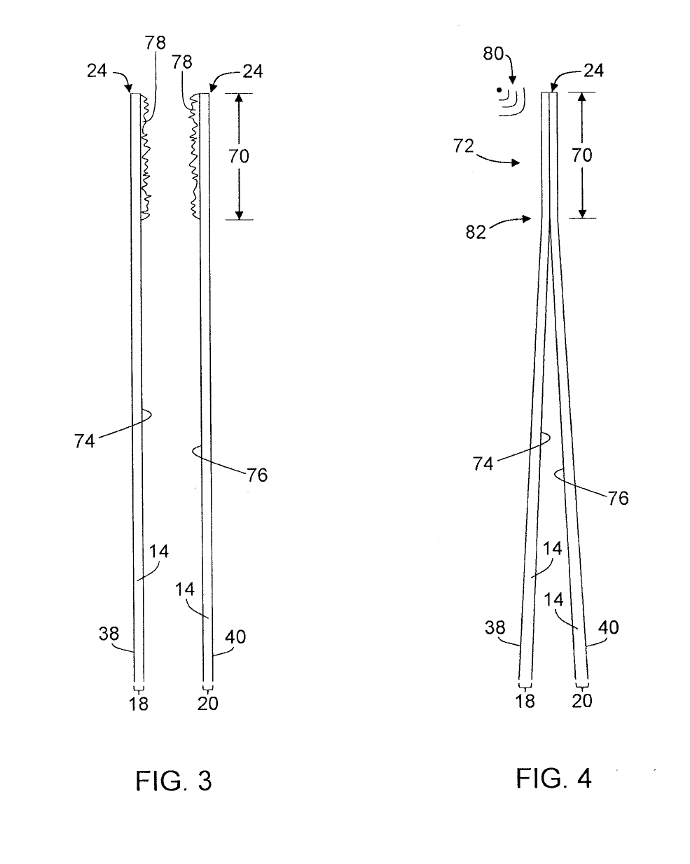

FIG. 3 is a cross sectional view of bag 10 with top portion 70 proximate to top end 24. FIG. 4 is a cross sectional view of bag 10 with top portion 70 internally sealed to create inner seal zone 72. Inner seal zone 72 is created by releasably coupling inner surface 74 of front wall 18 to inner surface 76 of rear wall 20. According to embodiments of the present invention, heat conduction from outer surfaces 38 or 40 of bag 10 through the woven layer 14 to reach inner surfaces 74 and 76 is not needed to create inner seal zone 72. In some embodiments, a bonding strength of inner seal zone 72 is chosen to facilitate separation of front wall inner surface 74 from rear wall inner surface 76 when an individual pulls zipper profiles 34 and 36 apart to open bag 10 for the first time.

In an exemplary embodiment, a coating material 78 is applied to front wall inner surface 74 and rear wall inner surface 76 along top portion 70. Coating material 78 is of a type that creates a bond when heated. In one embodiment, coating material 78 is applied in a patterned application. In an alternative embodiment, coating material 78 is applied in a full-surface application. After coating material 78 is applied, front wall inner surface 74 and rear wall inner surface 76 are positioned in substantial contact with each other in a zone 72 extending from top end 24 to a lower edge 82 of zone 72. In one embodiment, an electromagnetic energy source 80, which may be, but is not limited to, a radio frequency or UV radiation source, applies energy to top portion 70 such that localized heating occurs within coating material 78. The localized heating causes coating material 78 to form a releasable bond between front wall inner surface 74 and rear wall inner surface 76, creating an inner seal in zone 72. In an alternative embodiment, coating material 78 is of a type that creates a bond when pressurized, and inner seal zone 72 is created by subjecting top portion 70 to increased pressure. In yet another alternative embodiment, coating material 78 is of a type that creates a bond when subjected to sonic vibration, and inner seal zone 72 is created by subjecting top portion 70 to sonic vibration.

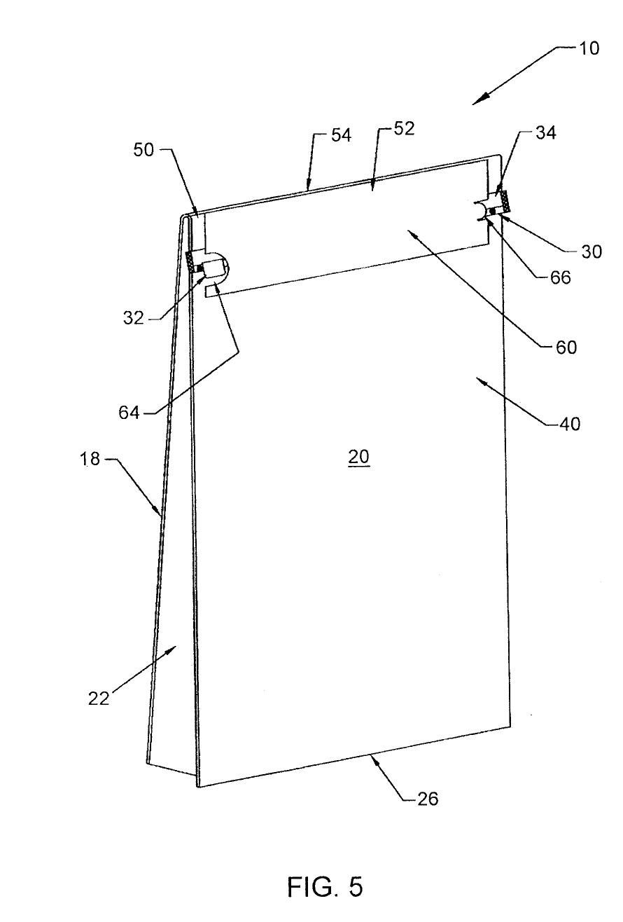

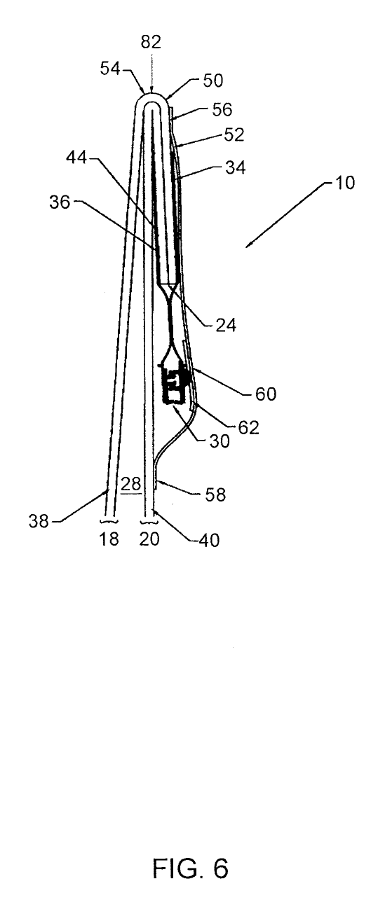

FIG. 5 is a perspective view of bag 10 with a top flap 50 of bag 10 folded over and secured using an adhesive member 52. FIG. 6 is a cross sectional view of bag 10 with top flap 50 folded over. In one embodiment, during assembly, bag 10 is folded along a hinge or crease 54 to define top flap 50. Hinge 54 includes fold lines through each layer of material in bag 10 and is positioned proximate to top end 24 of bag 10. In the exemplary embodiment, hinge 54 is formed at or near lower edge 82 of inner seal zone 72. Alternatively, hinge 54 may be formed below zone lower edge 82, such that the entirety of inner seal zone 72 is protected within top flap 50 after top flap 50 is folded over, or the hinge may be formed above zone lower edge 82, such that hinge 54 lies within inner seal zone 72. Additionally, hinge 54 is positioned a sufficient distance from top end 24 to provide an attachment area on bag 10 for adhesive member 52. As such, a strip of outer surface 40 of bag 10 is exposed between hinge 54 and zipper member 30, and adhesive member 52 is affixed to the strip of outer surface 40, as will be described in detail below. In the exemplary embodiment, when top flap 50 is folded over, rear wall 20 is folded over upon itself such that the portion of rear wall 20 defining top flap 50 contacts or is positioned proximate to rear wall 20. Additionally, when top flap 50 is folded over, outer portion 44 of second zipper profile 36 (i.e., the zipper profile coupled to rear wall 20) contacts or is positioned proximate to rear wall 20. Alternatively, when top flap 50 is folded over, front wall 18 is folded over upon itself and zipper profile 36 is positioned proximate front wall 18.

In assembly, when top flap 50 is folded over, in embodiments where hinge 54 is located at or beneath lower edge 82 of inner seal zone 72, top flap 50 and bag 10 define a false top at hinge 54. More particularly, during loading of product into bag 10 through bottom end 26, the product is restricted from moving beyond hinge 54. As such, the product is prevented from contacting inner seal zone 72, top end 24 of bag 10, and more importantly, zipper member 30. As such, impact forces on zipper member 30 are reduced and/or eliminated during the filling or loading of bag 10.

In the exemplary embodiment, adhesive member 52 includes a first adhesive portion or band 56 and a second adhesive portion or band 58. First adhesive portion 56 secures adhesive member 52 to front wall 18 and/or first zipper profile 34. Second adhesive portion 58 secures adhesive member 52 to rear wall 20. As such, adhesive member 52 extends along first zipper profile 34 and secures top flap 50 in the folded over position. In the exemplary embodiment, adhesive member 52 is secured to bag 10 such that adhesive member 52 has a substantially flat or planar configuration. Specifically, adhesive member 52 extends along the contour of bag 10 from top flap 50 towards bottom end 26 of bag 10 and does not wrap around or fold over or under top end 24 of bag 10.

Moreover, in the exemplary embodiment, adhesive member 52 includes a reinforced section or tear strip 60. Reinforced section 60 extends between first and second adhesive portions 56 and 58, respectively. In the exemplary embodiment, reinforced section 60 includes an area of reinforcement extending between first and second adhesive portions 56 and 58. In one embodiment, reinforced section 60 is reinforced with a plastic band 62 extending the length of reinforced section 60. In one embodiment, reinforced section 60 extends substantially the entire length of adhesive member 52. In another embodiment, adhesive member 52 includes a notched-out portion 64 at an edge of adhesive member 52 and aligned with reinforced section 60. In the exemplary embodiment, slider clip 32 is positioned within notched out portion 64 and is restricted from moving along zipper member 30 until reinforced section 60 is removed.

In use, severing of adhesive member 52 releases top flap 50 and allows access to zipper member 30, inner seal zone 72, and the contents of bag 10. Specifically, severing of adhesive member 52 may be accomplished by removing reinforced section 60. Additionally, removal of reinforced section 60 allows slider clip 32 to move along zipper member 30. In the exemplary embodiment, adhesive member 52 includes a pull tab 66 connected to one end of reinforced section 60. Pull tab 66 facilitates severing of reinforced section 60 along the area of reinforcement. Specifically, pull tab 66 is configured to separate at least a portion of reinforced section 60 from first and second adhesive portions 56 and 58.

It will be understood that the flap 50 of the bag 10 need not be folded over and secured with an adhesive member. In certain applications it may be desirable to leave the flap 50 unfolded and simply rely on the inner seal to protect the zipper member as the bag is loaded with product. Thus, the folded over and sealed flap is not a requirement of the invention, even though it represents a best mode of carrying out the invention.

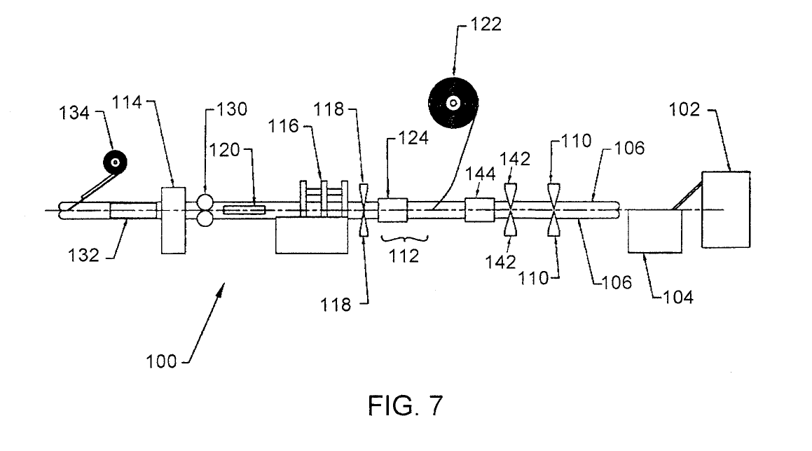

FIG. 7 is a schematic view of a forming machine 100 that may be used to form bag 10 (shown in FIGS. 1-6). Forming machine 100 includes a plurality of components used to form bag 10. In one embodiment, the components are generally grouped into four forming phases, a positioning or set-up phase; an inner sealing phase; a zipper/slider application phase; and a folding or finishing phase.

In the exemplary embodiment, forming machine 100 includes a bag feeder 102, a registration table 104, and transporting members 106. Components 102,104 and 106 are utilized in the positioning phase. Specifically, bag feeder 102 houses multiple, preformed tubular multiwall bags 10. Feeder 102 feeds individual bags 10 onto registration table 104. Registration table 104 aligns and positions bags 10 squarely and consistently as bags 10 are transferred downstream to the remaining components of forming machine 100. Specifically, registration table 104 aligns each bag 10 parallel to each other bag 10 and aligns top ends 24 (shown in FIG. 1) of bags 10. As such, top ends 24 of bags 10 are positioned to receive zipper members 30 (shown in FIG. 2). As bags 10 are accepted onto registration table 104, bags 10 are consistently spaced from a trailing edge of one bag 10 to a leading edge of another bag 10 (i.e., a consistent spacing between side walls 22 of adjacent bags 10). Additionally, transporting members 106 cooperate with registration table 104 for aligning, securing and transporting bags 10 and maintaining the relative positions of bags 10. In one embodiment, transporting members 106 include belts, such as conveyor type belts, that are positioned on opposing sides of and engaging bags 10, thus securing bags 10 therebetween. Also, transporting members 106 facilitate transferring bags 10 downstream to the remaining components of forming machine 100.

In the exemplary embodiment, forming machine 100 also includes a coating material applicator 142 and sealing unit 144. Components 142 and 144 are utilized in the inner sealing phase. Bags 10 are transferred to coating material applicator 142 by transporting members 106. In an exemplary embodiment, applicator 142 applies coating material 78 to front wall inner surface 74 and rear wall inner surface 76 of top portion 70 of bag 10 (shown in FIG. 3). In one embodiment, coating material 78 is applied by a pattern applicator. In an alternative embodiment, coating material 78 is applied as a full-surface application. Bags 10 are then transferred to sealing unit 144. Sealing unit 144 brings front wall inner surface 74 and rear wall inner surface 76 into substantial contact with each other along zone 72 (shown in FIG. 4). In one embodiment, sealing unit 144 includes an electromagnetic energy source 80, which may be, but is not limited to, a radio frequency or UV source, that applies energy to top portion 70 such that localized heating occurs within coating material 78. In an alternative embodiment, sealing unit 144 pressurizes top portion 70. In yet another alternative embodiment, sealing unit 144 sonically vibrates top portion 70. Sealing unit 144 causes coating material 78 to form a releasable bond between front wall inner surface 74 and rear wall inner surface 76, creating inner seal zone 72 (shown in FIG. 4). Bags 10 are then transferred to slider applicator system 112.

In the exemplary embodiment, forming machine 100 also includes a first adhesive applicator 110, a slider applicator system 112, and a cutter 114. In one embodiment, forming machine also includes a zipper member sealing system 116, a second adhesive applicator 118, and a venturi 120. Components 110, 120 are utilized in the zipper/slider application phase.

Bags 10 are transferred to first adhesive applicator 110 by transporting members 106. As bags 10 are transferred past applicator 110, adhesive is applied to bag 10. In one embodiment, adhesive is applied to front and rear walls 18 and 20 (shown in FIG. 1) proximate top end 24 of bag 10. In one embodiment, adhesive is applied as a continuous bead. In another embodiment, adhesive is applied as individual bead drops. Bags 10 are then transferred to slider applicator system 112.

Slider applicator system 112 includes a zipper applicator 122 and a slider applicator 124. Zipper applicator 122 attaches zipper member 30 to bags 10, and slider applicator 124 attaches slider clips 32 to zipper member 30. Alternatively, slider clips 32 are attached to zipper member 30 and the zipper/slider combination is attached as a unit to bags 10. In the exemplary embodiment, zipper member 30 is attached as a continuous web or ribbon to bags 10 as bags 10 are transferred past slider applicator system 112. In one embodiment, the flanges of first and second zipper profiles 34 and 36 are adhered or otherwise secured to the adhesive beads applied to bags 10 by first adhesive applicator 110. Alternatively, the adhesive beads are applied directly to zipper member 30 prior to joining zipper member 30 to bag 10. Furthermore, in the exemplary embodiment, zipper applicator 122 activates the adhesive by an application of direct heat, wherein at least one of the temperature and direction of the applied heat is controlled to substantially limit the amount of heat conducted into the interior of woven layer 14 of bag 10. Alternatively, the adhesive may be activated by one of electromagnetic energy, external pressure, and sonic vibration. In the exemplary embodiment, after zipper member 30 is attached to bags 10, slider clip 32 is coupled to the tracks of zipper member 30.

In one embodiment, bags 10 are transferred from slider applicator system 112 to zipper member sealing system 116. Sealing system 116 seals the flanges of first and second zipper profiles 34 and 36 to one another at opposite sides of the bag to form end portions of zipper member 30. In one embodiment, sealing system 116 is an ultrasonic sealer. In one embodiment, sealing system 116 includes an actuator (not shown) configured to move multiple sealing units with bags 10. As a result, multiple bags 10 may be sealed simultaneously.

In one embodiment, bags 10 are transferred from slider applicator system 112 to second adhesive applicator 118. Second adhesive applicator 118 applies beads of adhesive to the outer portion of first and second zipper profiles 34 and 36. As such, the beads of adhesive, or glue drops, function as end stops for slider clip 32. Additionally, in one embodiment, forming machine 100 includes venturi 120. Venturi 120 directs airflow to the glue drops to facilitate quick cooling and curing of the glue drops as bags 10 are transferred downstream. In an alternative embodiment, rather than second adhesive applicator 118, forming machine includes an alternative end stop applicator.

In the exemplary embodiment, bags 10 are transferred downstream of slider applicator system 112 to cutter 114. As indicated above, zipper member 30 is applied to bags 10 as a continuous ribbon. As such, zipper member 30 extends between and connects the individual bags 10 to one another. Cutter 114 facilitates cutting zipper member 30 between bags 10 such that bags 10 are no longer connected to one another.

Moreover, in the exemplary embodiment, forming machine 100 includes a creasing member 130, a folding station 132, and an adhesive member applicator 134. Components 130-134 are utilized in the folding phase. In the exemplary embodiment, creasing member 130 includes a wheel having a wedge shaped edge. Creasing member 130 forms fold lines in bag 10 which ultimately define hinge 54 (shown in FIG. 5). In one embodiment, creasing member 130 is utilized to crease bags 10 prior to bags 10 being cut by cutter 114.

Bags are transferred from creasing member 130 to folding station 132. At folding station 132, top flap 50 (shown in FIG. 5) is folded over at hinge 54 created by creasing member 130. In one embodiment, folding station 132 includes a plurality of rails that engage top flap 50 of bag 10 and fold top flap about hinge 54. The rails also secure top flap 50 in a folded over position as bags 10 are transferred to adhesive member applicator 134.

Adhesive member applicator 134 houses a web of adhesive members 52. As bags 10 are transferred past adhesive member applicator 134, the individual adhesive members 52 are attached to bags 10 proximate top flap 50. Specifically, adhesive members 52 are attached to both front and rear walls 18 and 20 of bag 10 and extend along first zipper profile 34 (shown in FIG. 5). As a result, adhesive members 52 secure top flaps 50 in the folded over position.

A single ply woven bag and a machine for forming the woven bag are now provided. The top end of the woven bag includes a reclosable closure member, such as a zipper member and a slider for opening and closing the zipper member. The woven bag is configured for bottom loading of a product, and during loading, the top end of the woven bag is subject to impact forces. Therefore, the woven bag includes an inner seal and is also designed such that the top end of the bag is folded over. An adhesive member is attached to the top flap to retain the top flap in a folded over position. The adhesive member extends along one side of the zipper profile and is secured to both the front and rear walls. When the inner seal is created and the top flap is folded over, the impact forces from loading of the woven bag are substantially reduced and/or eliminated. The inner seal further provides a barrier to infiltration of atmospheric gases and insects and facilitates vacuum packing or gas flushing of the package head space. Furthermore, the reclosable closure member is affixed and the inner seal is created without the need for heat conduction from the outside surface of the woven ply to the inside surface of the woven ply. To access the contents of the multiwall bag, a reinforced section extending through the adhesive member is removed, the adhesive member is severed, and the inner seal is pulled apart. Additionally, the adhesive member and inner seal function as tamper evident members. As a result, an improved single ply woven bag is provided in a cost effective and reliable manner.

Adhesive bonds have been discussed for securing together the inner surfaces of the bag structure at its top end to form the inner seal zone 72. Preferably, the adhesive selected for this application is curable without the need to apply heat from the outside of the bag structure, as discussed above. A wide variety of pressure and radiation curable adhesives are available for such purposes. For example, Ultraviolet curable adhesives are available from Loxeal Engineering Adhesives, Permabond Engineering Adhesives, Master Bond, and Dymax Adhesives and Light Curing Systems. Radio frequency curable adhesives are available from A wide variety of adhesives

Exemplary embodiments of a woven bag are described above in detail. The bag is not limited to the specific embodiments described herein, but rather, components of each bag may be utilized independently and separately from other components described herein. Each bag component can also be used in combination with other bag components.

While the invention has been described in terms of various specific embodiments, those skilled in the art will recognize that the invention can be practiced with modification within the spirit and scope of the claims.

What is claimed is:

1. A bag comprising:
a generally tubular body having a top end, a front wall, and a rear wall and being fabricated of a plastic-based woven material;
the front wall having a top edge, an inner surface, and an outer surface;
the rear wail having a top edge, an inner surface, and an outer surface;
a first zipper member secured with an adhesive to the outer surface of the front wall extending along the top edge thereof;
a second zipper member secured with an adhesive to the outer surface of the rear wall extending along the top edge thereof;
a slider clip on the first and second zipper members for decoupling the zipper members to open the bag when slid in one direction and coupling the zipper members to close the bag when slid in the opposite direction.

2. The bag of claim 1 and wherein the adhesive is activated by exposure to one of direct heat, electromagnetic energy, pressure, and sonic vibration.

3. The bag of claim 2 and wherein the direct heat comprises heat applied with one of controlled temperature or controlled direction to limit the amount of heat conducted from the front and rear wall outer surfaces to the front and rear wall inner surfaces.

4. The bag of claim 1 and wherein the tubular body further comprises side walls and wherein the side walls are gusseted.

5. The bag of claim 1 and wherein the first and second zipper members extend beyond the ends of the top edges of the bag to form tails.

6. The bag of claim 5 and wherein the tails are affixed together at each end of the top edges.

7. The bag of claim 1 and wherein the plastic-based woven material comprises a woven polypropylene material.

8. The bag of claim 1 and wherein the plastic-based woven material comprises a woven polyethylene material.

9. The bag of claim 1 and wherein the plastic-based woven material comprises a woven polymer material.

10. The bag of claim 1 and wherein the top end of the tubular body is folded onto itself to position the zipper members against the front wall or the back wall of the bag.

11. The bag of claim 10 and further comprising an adhesive member securing the top end in its folded position and at least partially covering the zipper members.

12. The bag of claim 11 and wherein the adhesive member includes a tear strip configured to separate the adhesive member when pulled to expose the zipper members and allow the bag to be opened.

13. The bag of claim 1 and further comprising a releasable adhesive on the inner surfaces of the front and rear walls along the top of the tubular body forming a releasable bond between the front and rear walls.

14. The bag of claim 13 and wherein the releasable adhesive comprises an adhesive is curable by the application on one of electromagnetic radiation, pressure, or ultrasonic vibration.

15. The bag of claim 14 and wherein the adhesive is curable by radio frequency radiation.

16. A method of forming a bag comprising the steps of:
(a) forming from a plastic-based woven material a tubular body having a first end, a front wall, and a rear wall, the front and rear walls having exterior and interior surfaces;
(b) applying a first zipper member to the exterior surface of the front wall extending along the first end of the bag with an adhesive between the first zipper member and the exterior surface of the front wall;
(c) applying a second zipper member to the exterior surface of the rear wall extending along the first end of the bag with an adhesive between the second zipper member and the exterior surface of the rear wall;
(e) applying a slider clip to the first and second zipper members; and
(f) setting the adhesive.

17. The method of claim 16 and wherein step (f) comprises applying direct heat to the zipper members.

18. The method of claim 17 and further comprising controlling one of the temperature and direction of the applied heat to limit substantially the amount of heat conducted from the exterior surfaces to the interior surfaces of the bag.

19. The method of claim 16 and wherein step (f) comprises exposing the adhesive to one of electromagnetic energy, external pressure, and sonic vibration.

20. The method of claim 16 and further comprising applying a second adhesive to the interior surfaces of the front and rear walls along the top end of the bag and setting the second adhesive.

21. The method of claim 20 and wherein the step of setting the second adhesive comprises exposing the second adhesive to one of electromagnetic radiation, external pressure, and sonic vibration.

22. The method of claim 16 and further comprising the steps of folding the top of the bag over until the zipper members overlie the front or the rear wall of the bag and applying an adhesive member over the folded portion to maintain its folded configuration and cover the zipper members until use.

23. The method of claim 22 and wherein the adhesive member includes a tear strip for separating the adhesive member to provide access to the zipper members for opening up the bag.
